(19) United States
(12) Patent Application Publication
(10) Pub. No.: US 2025/0316815 A1
(43) Pub. Date: Oct. 9, 2025

(54) BATTERY PACK

(71) Applicant: SAMSUNG SDI CO., LTD., Yongin-si (KR)

(72) Inventor: Sanghun PARK, Yongin-si (KR)

(21) Appl. No.: 19/089,293

(22) Filed: Mar. 25, 2025

(30) Foreign Application Priority Data
Apr. 9, 2024 (KR) 10-2024-0047861

(51) Int. Cl. H01M 50/24; H01M 50/262

(52) U.S. Cl. CPC H01M 50/24; H01M 50/262

(57) ABSTRACT

A battery pack includes a battery cell accommodated in a housing and the housing including an attachment area recessed to provide a position on a surface of the housing where an attachment object is attached. The attachment area may include a through-portion and an engraved pattern. The through-portion may be formed to penetrate the attachment area and be in fluid communication with an inner area of the housing. The engraved pattern may be configured to provide an air flow path between the attachment object and the attachment area.

### CROSS-REFERENCE TO RELATED APPLICATION

The present application claims priority and the benefit of Korean Patent Application No. 10-2024-0047861, filed on Apr. 9, 2024, in the Korean Intellectual Property Office, the entire disclosure of which is incorporated herein by reference.

### BACKGROUND

### 1. Field

One or more embodiments relate to a battery pack.

### 2. Description of the Related Art

Secondary batteries are chargeable and dischargeable multiple times to enable repeated use. Secondary batteries are used as energy sources for mobile devices, electric vehicles, hybrid vehicles, electric bicycles, uninterruptible power supplies, and the like. Depending on the type of an external device to which secondary batteries are applied, secondary batteries may be used in the form of a single battery or a module where a plurality of batteries are connected into one unit.

### SUMMARY

One or more embodiments include a battery pack, in which an attachment object including information about the battery pack may be stably attached to a housing.

One or more embodiments include a battery pack, in which air bubbles may be prevented from being formed between an attachment area and an attachment object.

Additional aspects will be set forth in part in the description which follows and, in part, will be apparent from the description, or may be learned by practice of the embodiments of the present disclosure.

According to one or more embodiments, a battery pack includes a housing including an attachment area recessed from a surface of the housing, and an attachment object attached to the attachment area, and a battery cell accommodated in the housing,, wherein the attachment area may include a through-portion and an engraved pattern, the through-portion may be formed to penetrate the attachment area and provide fluid communication with an inner area of the housing, and the engraved pattern may be configured to provide an air flow path between the attachment object and the attachment area.

The attachment area may be recessed from the surface of the housing to a first depth, and the engraved pattern may be formed to be recessed from the surface of the housing to a second depth that is greater than the first depth.

The engraved pattern surrounds the through-portion.

The air flow path may be configured such that one end portion of the air flow path is connected to the through-portion.

The through-portion may have a circular cross-sectional shape.

The engraved pattern may be symmetrical with respect to the through-portion.

The engraved pattern may radially extend from the through-portion.

The attachment area may include a moisture prevention line recessed from the surface of the housing and surrounding the engraved pattern.

The moisture prevention line may be recessed to the second depth.

The attachment area may include a first attachment area and a second attachment area each including a through-portion and an engraved pattern.

The attachment area may include an auxiliary support portion formed at a contact boundary between the first attachment area and the second attachment area.

The auxiliary support portion may be recessed from the surface of the housing to a third depth that is greater than the first depth.

The auxiliary support portion may be disposed between the through portion of the first attachment area and the through portion of the second attachment area.

The sum of areas having the first depth in the attachment area may be about 50% or more of the attachment area.

plurality of the through-portion may be provided in the attachment area.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view of a battery pack according to an embodiment;

FIG. 2 is an exploded perspective view of a battery pack according to an embodiment, from which an upper housing is disassembled;

FIG. 3 is an exploded perspective view of the battery pack of FIG. 2, from which an inner cover is disassembled;

FIG. 4 is an enlarged view for explaining an attachment area according to an embodiment;

FIG. 5 is an enlarged view for explaining a moisture prevention line according to an embodiment;

FIG. 6 is a conceptual view for explaining a moisture prevention line according to an embodiment;

FIG. 7 is a perspective view for explaining the attachment area of a housing according to an embodiment; and

FIG. 8 is a schematic cross-sectional view of the attachment area of FIG. 7 taken along an A-A.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

Hereinafter, an embodiment of the disclosure is described in detail with reference to the accompanying drawings. The terms used in the disclosure are those selected from currently widely used general terms in consideration of functions in the disclosure. However, the terms may vary according to an engineer's intention, precedents, or advent of new technology. Also, for special cases, terms selected by the applicant are used, in which meanings the selected terms are described in detail in the description section. Accordingly, the disclosure will now be described more fully with reference to the accompanying drawings, in which embodiments of the disclosure are shown. In the following description, when detailed descriptions about related well-known functions or structures are determined to make the gist of the disclosure unclear, the detailed descriptions will be omitted herein. Furthermore, in the specification, terms such as “include (including)” or “comprise (comprising)” may be construed to denote a certain characteristic, number, step, operation, component, or a combination thereof, but may not be construed to exclude the existence of or a possibility of addition of one or more other characteristics, numbers, steps, operations, components, or combinations thereof. Furthermore, when describing embodiments of the disclosure, terms “can do . . . ” and “can be . . . ” may include “one or more embodiments.”

Furthermore, to help understanding of the disclosure, the accompanying drawings are not illustrated down to actual scale, but are illustrated to be exaggerated in dimensions of some components. Furthermore, in different embodiments, like elements may be assigned with like reference numerals.

Two comparison objects being mentioned to be “the same” means to be “substantially the same”. Accordingly, the being substantially the same may include a case of having a deviation regarded as a low level in the field to which the disclosure pertains, for example, within 5%. Furthermore, a parameter being uniform in a certain area may mean being uniform from an average perspective.

Terms such as “first” and “second” are used herein merely to describe a variety of components, but the components are not limited by the terms. Such terms are used only for the purpose of distinguishing one component from another component. For example, without departing from the right scope of the disclosure, a first component may be referred to as a second component, and vice versa.

Thus, an expression used in a singular form in the specification also includes the expression in its plural form unless clearly specified otherwise in context.

When a component is disposed “above (or under)” or “on (or below)” to another component, not only the component may be only directly on an upper surface (or lower surface) of the other component, but also another component may be provided between the component and a certain component disposed on (or below) the other components.

Furthermore, when a component is “connected,” “coupled,” or “contacted” to another component, the component contacts or is connected to the other component directly or the component should be construed to be “connected,” “coupled,” or “contacted” to another component through at least one of other components. Furthermore, when a component “connects” or is “connected” to another component, the component contacts or is connected to the other component not only directly, but also electrically through at least one of other components interposed therebetween.

In the specification, the expression such as “A and/or B” may include A, B, or A and B. As used herein, the term “and/or” includes any and all combinations of one or more of the associated listed items. As used herein, the term “C to D” means C or more and D or less, unless otherwise specified.

Hereinafter, a battery pack 1 according to an embodiment is described with reference to the accompanying drawings.

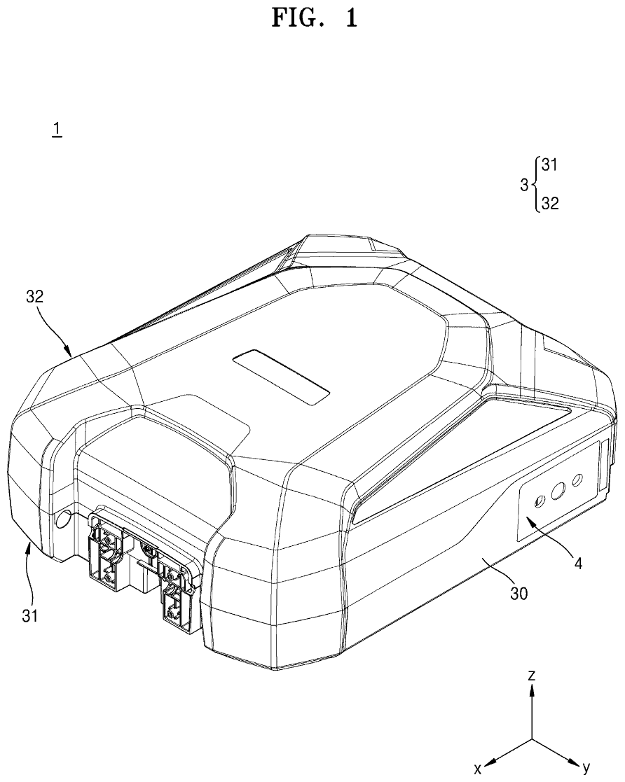

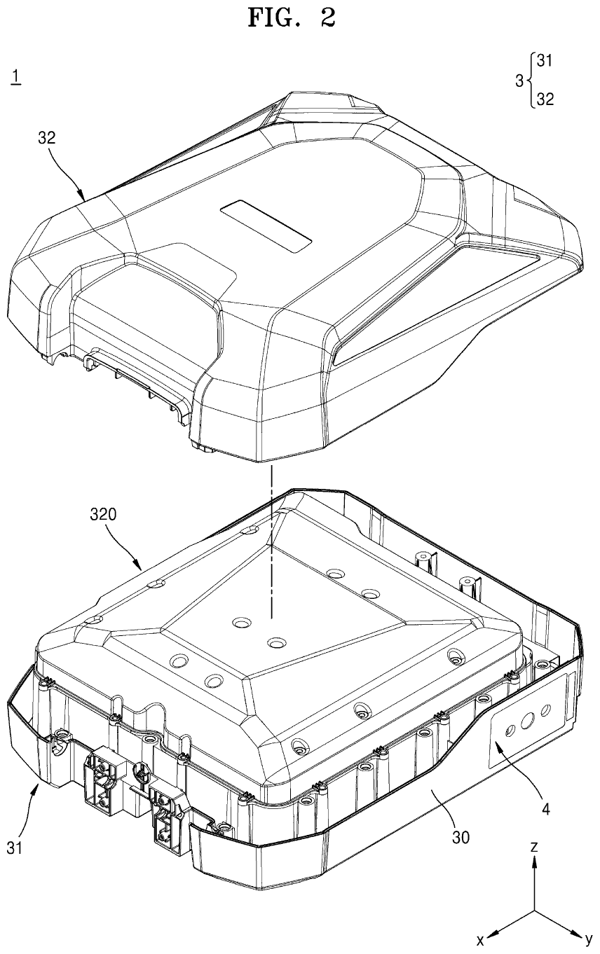

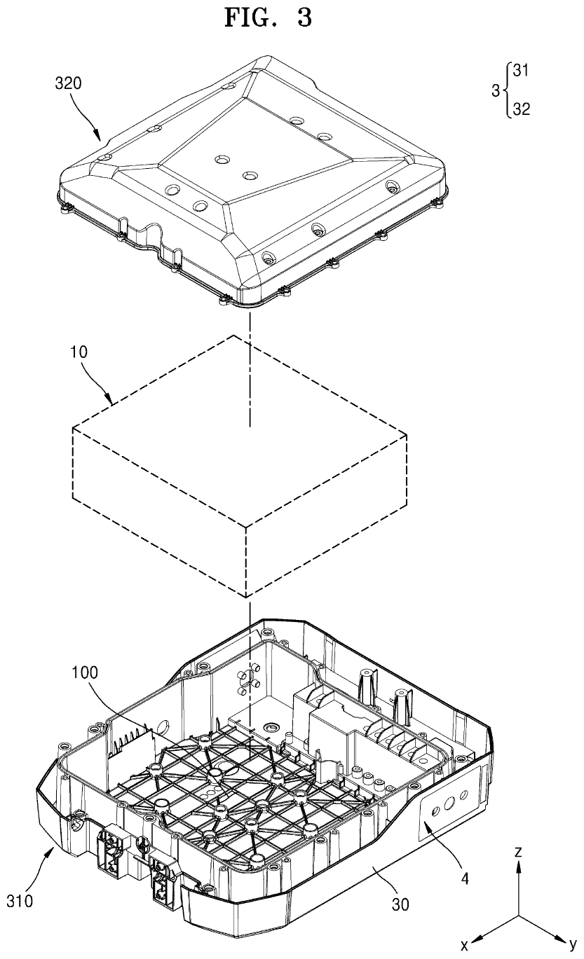

FIG. 1 is a perspective view of the battery pack 1 according to an embodiment. FIG. 2 is an exploded perspective view of the battery pack 1 according to an embodiment, from which an upper housing 32 is disassembled; FIG. 3 is an exploded perspective view of the battery pack 1 of FIG. 2, from which an inner cover 320 is disassembled.

Referring to FIGS. 1 to 3, the battery pack 1 according to an embodiment may include a housing 3 configured to accommodate a battery cell 10. The battery cell 10 may be accommodated in the housing 3. The housing 3 may include a lower housing 31, an upper housing 32, and an inner cover 320. The lower housing 31, the upper housing 32, and the inner cover 320 may protect the battery cell 10. The lower housing 31 may include an accommodation portion 100 that accommodates the battery cell 10. That is, the battery cell 10 may be accommodated in the accommodation portion 100 of the lower housing 31. The inner cover 320 may cover the accommodation portion 100 of the lower housing 31 from the top. The upper housing 32 may be coupled to the lower housing 31. The inner cover 320 may cover the battery cell 10 from the top. The upper housing 32 may cover the inner cover 320 from the top. The inner cover 320 may be coupled to the lower housing 31. The battery cell 10 may be double protected by the inner cover 320 and the upper housing 32. However, the above descriptions about the arrangements and functions of the lower housing 31, the upper housing 32, and the inner cover 320 are only an example, and the disclosure is not limited thereto.

The housing 3 according to an embodiment may constitute the appearance of the battery pack 1. The housing 3 may deliver information about the battery pack 1 to a user. The delivery of the information about the battery pack 1 by the housing 3 to a user may include delivering information about the battery pack 1 provided on a surface 30 of the housing 3 to a user. Herein, information about the battery pack 1 provided on the surface 30 of the housing 3 may include not only information provided on the surface 30 of the housing 3, but also information may be indirectly provided on the surface 30 by an object containing information about the battery pack 1 that is arranged on the surface 30 of the housing 3. In other words, by arranging an object containing information about the battery pack 1 on the surface 30 of the housing 3, the information about the battery pack 1 may be provided to a user.

The battery pack 1 may have certain specifications that indicated by the information. The specifications of the battery pack 1 may be information about, for example, a voltage, a capacity, an output, a handling method, and the like. Further, the specifications of the battery pack 1 may be information about, for example, a size, a weight, and the like of the battery pack 1. However, the information about the specifications of the battery pack 1 is not limited to the above descriptions, and may include a wide range of other types of information. When the information about the specifications of the battery pack 1 is marked on the battery pack 1, a user may use the information according to the purpose of the battery pack 1.

Furthermore, certain specifications of the battery pack 1 may be set differently according to the user's necessity. In other words, the battery pack 1 may have different specifications according to purposes and applied product groups. To quickly deliver the information about the specifications of the battery pack 1 to a user, the information about the specifications of the battery pack 1 may be marked on the appearance (i.e., outside) of the battery pack 1.

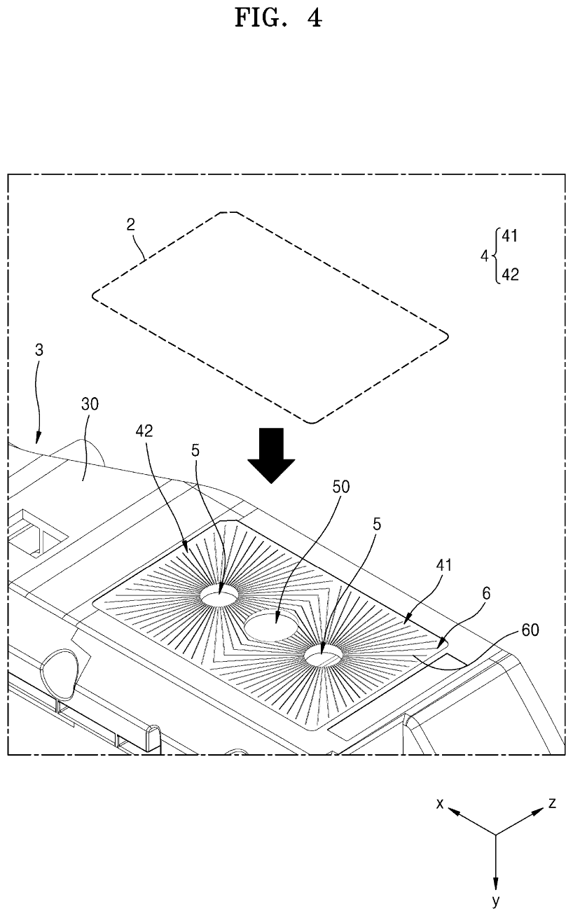

FIG. 4 is an enlarged view for explaining an attachment area 4 according to an embodiment.

Referring to FIGS. 1 to 4, the housing 3 according to an embodiment may include the attachment area 4 formed on the surface 30. The surface 30 of the housing 3 may constitute a portion of the appearance of the battery pack 1. The attachment area 4 may provide a position on the battery pack 1 where an attachment object 2 is attached. That is, the attachment area 4 may provide a position on the surface 30 of the housing 3 where the attachment object 2 is attached. The area of the attachment area 4 may be formed to be greater than the area of the attachment object 2. The attachment object 2 may include information about the battery pack 1. It should be noted that, although the attachment object 2 may include the information about the specifications of the battery pack 1, such a type of information is merely an example, and the disclosure is not limited thereto. The attachment object 2 may have a certain thickness. For example, the thickness of the attachment object 2 may be about 0.1 mm to about 0.2 mm, but the disclosure is not limited thereto. In some embodiments, the thickness of the attachment object 2 may be about 0.12 mm to about 0.13 mm, but the disclosure is not limited thereto.

The attachment area 4 of the housing 3 according to an embodiment may be formed to be recessed in the surface 30 to provide a position on the surface 30 of the housing 3 where the attachment object 2 is attached. That is, the attachment area 4 may be formed to be recessed inward from the outer surface 30 of the housing 3. The recess depth of the attachment area 4 may be less than the thickness of the attachment object 2. When the recess depth of the attachment area 4 is less than the thickness of the attachment object 2, the attachment object 2 attached to the attachment area 4 may be disposed higher than the surface 30 of the housing 3. For example, the recess depth of the attachment area 4 from the surface 30 of the housing 3 may be about 0.01 mm to about 0.05 mm, but the disclosure is not limited thereto.

In a process of attaching the attachment object 2 to the attachment area 4, air may be provided between the attachment area 4 and the attachment object 2. In the process of attaching the attachment object 2 to the attachment area 4, air bubbles may be formed between the attachment area 4 and the attachment object 2. When the air bubbles formed between the attachment area 4 and the attachment object 2 are not discharged, the appearance of the battery pack 1 may deteriorate. Further, when the air bubbles formed between the attachment area 4 and the attachment object 2 are not discharged, the attachment strength of the attachment object 2 in the attachment area 4 may not be good. And when the air bubbles formed between the attachment area 4 and the attachment object 2 are not discharged, the condition of the attachment object 2 may deteriorate. In detail, when the air bubbles formed between the attachment area 4 and the attachment object 2 are not discharged, the air bubbles repeatedly contract and expand according to the temperature change of the battery pack 1, and, thus, the condition of the attachment object 2 may deteriorate. In particular, when the air bubbles formed between the attachment area 4 and the attachment object 2 are condensed in a specific area, the condition of the attachment object 2 may deteriorate.

The attachment area 4 according to an embodiment may include a through-portion (hole) 5. The through-portion 5 may be formed to penetrate the attachment area 4 and be in fluid communication with an inner area of the housing 3. The through-portion 5 may connect the surface 30 of the housing 3 to the inner area of the housing 3 within the attachment area 4. The through-portion 5 may guide the air bubbles formed between the attachment area 4 and the attachment object 2 to move toward the inner area of the housing 3. That is, the air bubbles formed between the attachment area 4 and the attachment object 2 may be moved toward the inner area of the housing 3. The through-portion 5 may prevent air bubbles from being formed between the attachment area 4 and the attachment object 2. Thus, the through-portion 5 may prevent the deterioration of the appearance of the battery pack 1 and the condition of the attachment object 2 in the attachment area 4. However, the function and role of the through-portion 5 are not limited to the descriptions presented above. As shown in FIG. 4, two through-portions 5 may be formed in the attachment area, but the number of through-portions 5 is not limited in the present disclosure.

The through-portion 5 according to an embodiment may have a certain cross-sectional shape within the attachment area 4 and may connect the surface 30 of the housing 3 to the inner area of the housing 3. For example, the through-portion 5 may have a circular cross-sectional shape, but the disclosure is not limited thereto.

The attachment area 4 according to an embodiment may include an engraved pattern 6. The engraved pattern 6 may be configured to provide an air flow path 60 between the attachment object 2 and the attachment area 4. The engraved pattern 6 may be formed to be recessed in the attachment area 4 and may provide the air flow path 60 to the attachment area 4. The air flow path 60 provided by the engraved pattern 6 may include a plurality of air flow paths. In an embodiment, the engraved pattern 6 is formed by a laser marking process in the attachment area 4, but the disclosure is not limited thereto. For example, the engraved pattern 6 may be formed by a gas venting process. Moreover, any process capable of providing the air flow path 60 between the attachment area 4 and the attachment object 2 may be a process used in the disclosure.

The engraved pattern 6 according to an embodiment may provide the air flow path 60 for air bubbles formed between the attachment area 4 and the attachment object 2. The engraved pattern 6 may prevent the air bubbles formed between the attachment area 4 and the attachment object 2 from being condensed in a specific area.

The engraved pattern 6 according to an embodiment may be formed to surround the through-portion 5. In other words, in the attachment area 4, the through-portion 5 may be disposed at a central portion and the engraved pattern 6 may be disposed in a peripheral portion. The air flow path 60 provided by the engraved pattern 6 may be formed to surround the through-portion 5.

The air flow path 60 provided by the engraved pattern 6 according to an embodiment may be configured such that one end portion of the air flow path 60 is connected to the through-portion 5. When one end portion of the air flow path 60 is connected to the through-portion 5, air bubbles formed between the attachment area 4 and the attachment object 2 may move toward the inner area of the housing 3 through the air flow path 60.

The engraved pattern 6 according to an embodiment may be symmetrically formed with respect to the through-portion 5. When the engraved pattern 6 is symmetrically formed with respect to the through-portion 5, the attachment object 2 may be stably attached to the attachment area 4. In detail, the engraved pattern 6 may be formed radially from the through-portion 5. When the engraved pattern 6 is formed radially from the through-portion 5, the attachment object 2 may be stably attached to the attachment area 4.

The engraved pattern 6 according to an embodiment may guide air bubbles formed between the attachment area 4 and the attachment object 2 to move toward the inner area of the housing 3. Further, the engraved pattern 6 may prevent the formation of air bubbles between the attachment area 4 and the attachment object 2. The engraved pattern 6 may prevent the deterioration of the appearance of the battery pack 1, and the engraved pattern 6 may prevent the deterioration of the condition of the attachment object 2 in the attachment area 4. However, the above description about the arrangement and function of the engraved pattern 6 is an example, and the disclosure is not limited thereto.

When the area of the attachment object 2 is relatively large, the attachment area 4 may include a plurality of attachment areas. The attachment object 2 may be attached across such a plurality of attachment areas. When the attachment area 4 includes a plurality of attachment areas, the attachment capability of the attachment object 2 may be excellent.

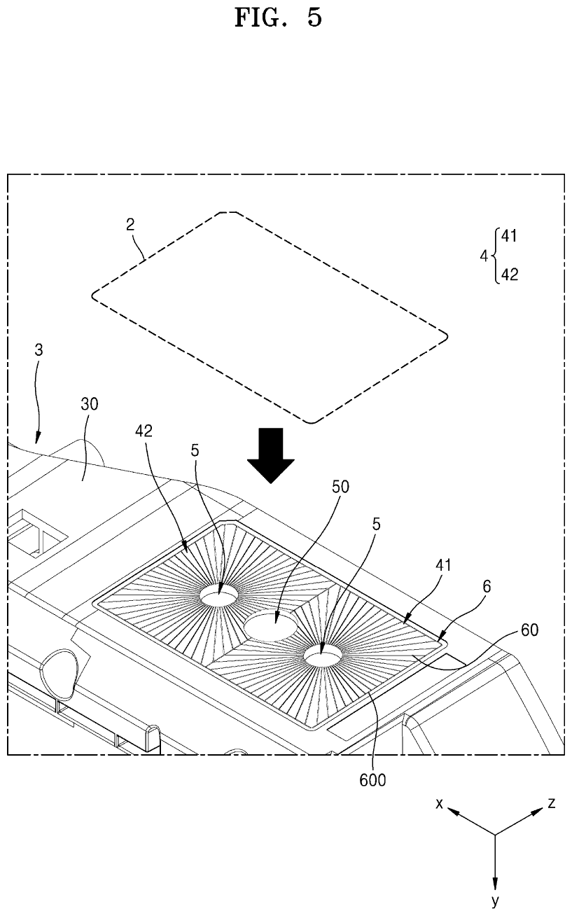

As shown in FIG. 5, the attachment area 4 according to an embodiment may include a plurality of attachment areas. The attachment areas 4 may each include the through-portion 5 and the engraved pattern 6. The attachment areas 4 may include a first attachment area 41 and a second attachment area 42. The first attachment area 41 and the second attachment area 42 may each include a through-portion 5 and an engraved pattern 6.

The first attachment area 41 and the second attachment area 42 according to an embodiment may be disposed parallel to each other. The first attachment area 41 and the second attachment area 42 being disposed parallel to each other means that the first attachment area 41 is connected to the second attachment area 42 on the surface 30 of the housing 3. However, the arrangement of the first attachment area 41 and the second attachment area 42 is not limited to the to the attachment area 41 and 42 being parallel to each other.

When the areas of the engraved patterns 6 arranged in the first attachment area 41 and the second attachment area 42 is excessive, the adhesion strength of the attachment object 2 attached to the attachment areas 41 and 42 may deteriorate. An auxiliary member capable of supporting the attachment object 2 may be necessary to stably attach the attachment object 2 to the attachment area 4.

The attachment area 4 according to an embodiment may include an auxiliary support portion 50 formed at a contact boundary between the first attachment area 41 and the second attachment area 42. The auxiliary support portion 50 may function to support the attachment object 2. That is, the auxiliary support portion 50 may provide an area in the attachment area 4 where the attachment object 2 is supported. The auxiliary support portion 50 may connect the engraved pattern 6 in the first attachment area 41 and the engraved pattern 6 in the second attachment area 42 to each other. And the auxiliary support portion 50 may connect the air flow path 60 in the first attachment area 41 and the air flow path 60 in the second attachment area 42 to each other.

The auxiliary support portion 50 according to an embodiment may be formed to be recessed to a certain depth from the attachment area 4. Further, the auxiliary support portion 50 may be disposed between the through-portions 5 neighboring each other. In other words, the auxiliary support portion 50 may be disposed between the through-portion 5 of the first attachment area 41 and the through-portion 5 of the second attachment area 42.

The auxiliary support portion 50 according to an embodiment may be formed to be circular. The cross-sectional area of the auxiliary support portion 50 may be greater than the cross-sectional area of the through-portion(s) 5. However, the shape and arrangement of the auxiliary support portion 50 are not limited to the descriptions presented above, and the auxiliary support portion 50 may have various shapes to capable of providing an area to support the attachment object 2 in the attachment area 4.

in some case, there may be a need to prevent infiltration of moisture between the attachment area 4 of the housing 3 and the attachment object 2. In other words, there may be a need to prevent moisture from outside of the battery pack from infiltrating through a gap formed between the attachment area 4 and the attachment object 2. In the following description, a moisture prevention line 600 formed in the attachment area 4 is described.

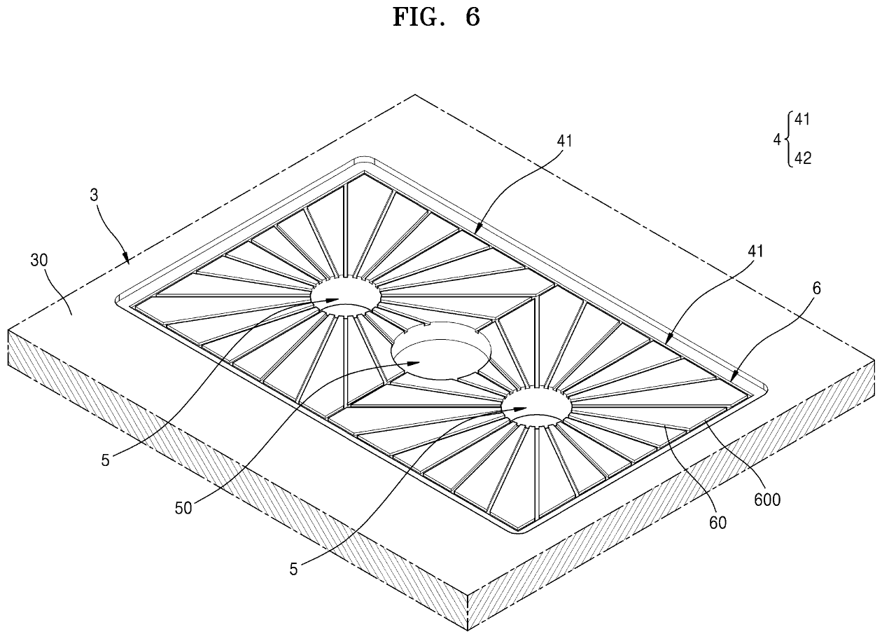

FIG. 5 is an enlarged view for explaining the moisture prevention line 600 according to an embodiment. FIG. 6 is a conceptual view for explaining the moisture prevention line 600 according to an embodiment.

Referring to FIGS. 1 to 6, the attachment area 4 of the housing 3 according to an embodiment may include the moisture prevention line 600. The attachment area 4 may include the moisture prevention line 600 that is recessed and surrounds the engraved pattern 6. In detail, the moisture prevention line 600 may be formed to surround an edge of the attachment area 4 and may guide an edge of the attachment object 2 to be stably attached to the attachment area 4. The attachment object 2 may cover the moisture prevention line 600 in the attachment area 4. The moisture prevention line 600 may guide the edge of the attachment object 2 to be stably disposed in the attachment area 4 and prevent the engraved pattern 6 from being exposed on the surface 30 of the housing 3. The moisture prevention line 600 may guide the edge of the attachment object 2 to be stably disposed in the attachment area 4 and prevent the air flow path 60 from being exposed on the surface 30 of the housing 3. And the moisture prevention line 600 may prevent infiltration of moisture through the gap between the attachment area 4 and the attachment object 2. However, the function and role of the moisture prevention line 600 are not limited to the descriptions presented above.

In the following description, the depths of the moisture prevention line 600, the engraved pattern 6, and the auxiliary support portion 50 recessed in the attachment area 4 are described in detail.

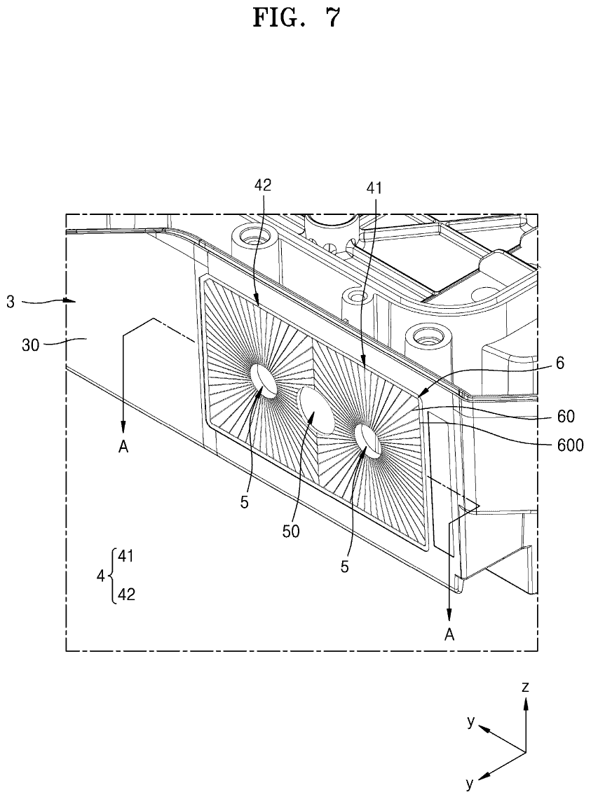

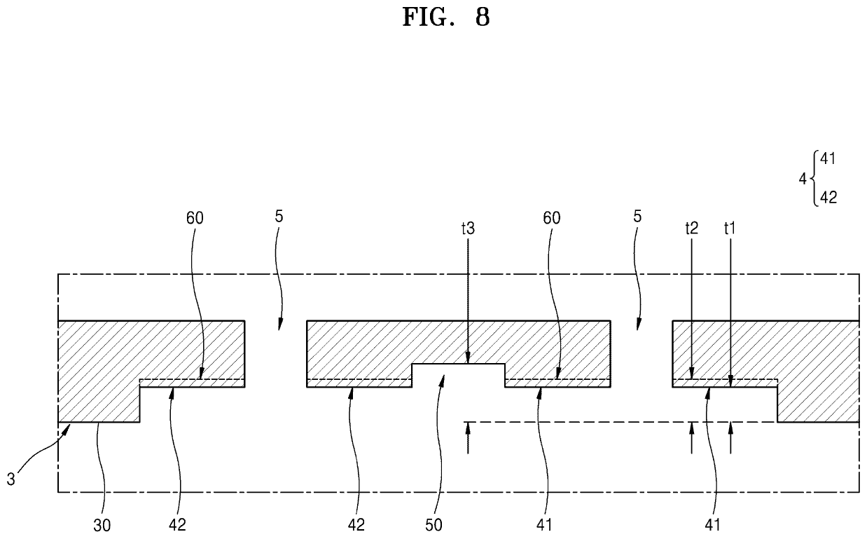

FIG. 7 is a perspective view for explaining the attachment area 4 of the housing 3 according to an embodiment. FIG. 8 is a schematic cross-sectional view of the attachment area 4 of FIG. 7 taken along an A-A. However, the cross-section illustrated in FIG. 8 may be exaggerated to describe the attachment area 4 according to an embodiment, and ratio relationships between the respective components may be different from that illustrated in FIG. 8.

Referring to FIGS. 5 to 8, the attachment area 4 according to an embodiment may be recessed from the surface 30 of the housing 3 to a first depth t1. The first depth t1 may be about 0.01 mm to about 0.05 mm, but the disclosure is not limited thereto.

The engraved pattern 6 according to an embodiment may be formed to be recessed from the surface 30 of the housing 3 to a second depth t2 that is deeper than the first depth t1. The formation of the engraved pattern 6 on the surface 30 of the housing 3 to the second depth t2 that is deeper than the first depth t1 may provide the air flow path 60 between the attachment object 2 attached to the attachment area 4 and the attachment area 4.

The moisture prevention line 600 according to an embodiment may be formed to be recessed to the second depth t2. The moisture prevention line 600 may be connected to the air flow path 60 provided by the engraved pattern 6, but the disclosure is not limited thereto.

The auxiliary support portion 50 according to an embodiment may be formed to be recessed from the surface 30 of the housing 3 to a third depth t3 that is deeper than the first depth t1. The third depth t3 may also be deeper than the second depth t2, but the disclosure is not limited thereto.

The sum of the sizes of the areas each having the first depth t1 in the attachment area 4 according to an embodiment may be about 50% or more of the size of the attachment area 4. The attachment object 2 may be stably attached to the attachment area 4 by an area having the first depth t1. However, the ratio of the size of the area having the first depth t1 to the size of the attachment area 4 is not limited to the description presented above in the attachment area 4. For example, even when the sum of the sizes of the areas having the first depth t1 in the attachment area 4 is about 50% or less of the size of the attachment area 4, the support of the attachment object 2 by the auxiliary support portion 50 may be such that the attachment object 2 is stably attached to the attachment area 4.

The battery pack according to one or more embodiments may provide an attachment area that is configured to allow an attachment object to be stably attached to a surface of a housing.

The battery pack according to one or more embodiments may prevent air bubbles from being formed between the attachment object and the attachment area.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure.

What is claimed is:

1. A battery pack comprising:
a housing including an attachment area recessed from a surface of the housing;
an attachment object attached to the attachment area; and
a battery cell accommodated in the housing;
wherein the attachment area comprises a through-portion and an engraved pattern, the through-portion is formed to penetrate the attachment area and provide fluid communication with an inner area of the housing, and the engraved pattern provides an air flow path between the attachment object and the attachment area.

2. The battery pack of claim 1, wherein the attachment area is recessed from the surface of the housing to a first depth, and the engraved pattern is recessed from the surface of the housing to a second depth that is greater than the first depth.

3. The battery pack of claim 2, wherein the engraved pattern surrounds the through-portion.

4. The battery pack of claim 3, wherein the air flow path is configured such that one end portion of the air flow path is connected to the through-portion.

5. The battery pack of claim 4, wherein the through-portion has a circular cross-sectional shape.

6. The battery pack of claim 5, wherein the engraved pattern is symmetrical with respect to the through-portion.

7. The battery pack of claim 6, wherein the engraved pattern extends radially from the through-portion.

8. The battery pack of claim 2, wherein the attachment area comprises a moisture prevention line recessed from the surface of the housing and surrounding the engraved pattern.

9. The battery pack of claim 8, wherein the moisture prevention line is recessed to the second depth.

10. The battery pack of claim 9, wherein the attachment area comprises a first attachment area and a second attachment area each comprising a through-portion and an engraved pattern.

11. The battery pack of claim 10, wherein the attachment area comprises an auxiliary support portion formed at a contact boundary between the first attachment area and the second attachment area.

12. The battery pack of claim 11, wherein the auxiliary support portion is recessed from the surface of the housing to a third depth that is greater than the first depth.

13. The battery pack of claim 12, wherein the auxiliary support portion is disposed between the through portion of the first attachment area and the through portion of the second attachment area.

14. The battery pack of claim 13, wherein a sum of areas having the first depth in the attachment area is about 50% or more of the attachment area.

15. The battery pack of claim 1, wherein a plurality of the through-portion is provided in the attachment area.
